(19) United States
(12) Patent Application Publication
(10) Pub. No.: US 2013/0323974 A1
(43) Pub. Date: Dec. 5, 2013

(54) SUBSTRATE-BASED INDUCTIVE DEVICES AND METHODS OF USING AND MANUFACTURING THE SAME

(71) Applicant: Pulse Electronics, Inc., San Diego, CA (US)

(72) Inventors: Aurelio J. Gutierrez, Bonita, CA (US); Christopher P. Schaffer, Fallbrook, CA (US)

(21) Appl. No.: 13/899,268

(22) Filed: May 21, 2013

Related U.S. Application Data
(60) Provisional application No. 61/650,395, filed on May 22, 2012.

(51) Int. Cl. H01F 5/00; H01R 43/00; H01R 13/66

(52) U.S. Cl. CPC H01F 5/003; H01R 13/6633; H01R 43/00
USPC 439/620.15; 336/200; 29/602.1

(57) ABSTRACT

Low-cost and high-precision inductive devices and methods of manufacturing and using the same. In one embodiment, the inductive device comprises a substrate-based inductive device which utilizes inserted conductive pins in combination with plated substrates which replace windings disposed around a magnetically permeable core. In some variations, these substrate-based inductive devices are integrated into a discrete electronic device. In another embodiment, the substrate-based inductive devices are incorporated into integrated connector modules. Methods of manufacturing and utilizing the aforementioned discrete substrate-based inductive devices and substrate-based integrated connector modules are also disclosed.

### PRIORITY AND RELATED APPLICATIONS

This application claims the benefit of priority to co-owned U.S. Provisional Patent Application Ser. No. 61/650,395 of the same title filed May 22, 2012, the contents of which are incorporated herein by reference in its entirety.

This application is also related to U.S. patent application Ser. No. 12/876,003, entitled “Substrate Inductive Devices and Methods” filed Sep. 3, 2010, the contents of which are incorporated herein by reference in its entirety. This application is also related to U.S. patent application Ser. No. 12/503,682, entitled “Substrate Inductive Devices and Methods” filed Jul. 15, 2009, which claims priority to co-owned U.S. Provisional Patent Application Ser. No. 61/135,243, entitled “Substrate Inductive Devices and Methods” filed Jul. 17, 2008, each of the foregoing incorporated herein by reference in its entirety. This application is also related to co-pending and co-owned U.S. patent application Ser. No. 11/985,156 filed Nov. 13, 2007 and entitled “WIRE-LESS INDUCTIVE DEVICES AND METHODS”, which claims the benefit of priority to co-owned U.S. Patent Provisional Application Ser. No. 60/859,120 filed Nov. 14, 2006 of the same title, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Technological Field

The present disclosure relates generally to circuit elements and more particularly in one exemplary aspect to inductors or inductive devices having various desirable electrical and/or mechanical properties, and methods of utilizing and manufacturing the same.

2. Description of Related Technology

In the electronics industry, as with many industries, the costs associated with the manufacture of various devices are directly correlated to the costs of the materials, the number of components used in the device, and/or the complexity of the assembly process. Therefore, in a highly cost-competitive environment such as the electronics industry, the manufacturer of electronic devices with designs that minimize cost (such as by minimizing the cost factors highlighted above) will maintain a distinct advantage over competing manufacturers.

The foregoing is especially true of inductors and other inductive devices (e.g., transformers). A myriad of different configurations of inductors and inductive devices are known in the prior art.

See for example, U.S. Pat. No. 3,614,554 to Shield, et al. issued Oct. 19, 1971 and entitled “Miniaturized Thin Film Inductors for use in Integrated Circuits”; U.S. Pat. No. 4,253,231 to Nouet issued Mar. 3, 1981 and entitled “Method of making an inductive circuit incorporated in a planar circuit support member”; U.S. Pat. No. 4,547,961 to Bokil, et al. issued Oct. 22, 1985 and entitled “Method of manufacture of miniaturized transformer”; U.S. Pat. No. 4,847,986 to Meinel issued Jul. 18, 1989 and entitled “Method of making square toroid transformer for hybrid integrated circuit”; U.S. Pat. No. 5,055,816 to Altman, et al. issued Oct. 8, 1991 and entitled “Method for fabricating an electronic device”; U.S. Pat. No. 5,126,714 to Johnson issued Jun. 30, 1992 and entitled “Integrated circuit transformer”; U.S. Pat. No. 5,257,000 to Billings, et al. issued Oct. 26, 1993 and entitled “Circuit elements dependent on core inductance and fabrication thereof'; U.S. Pat. No. 5,487,214 to Walters issued Jan. 30, 1996 and entitled “Method of making a monolithic magnetic device with printed circuit interconnections”; U.S. Pat. No. 5,781,091 to Krone, et al. issued Jul. 14, 1998 and entitled “Electronic inductive device and method for manufacturing”; U.S. Pat. No. 6,440,750 to Feygenson, et al. issued Aug. 27, 2002 and entitled “Method of making integrated circuit having a micromagnetic device”; U.S. Pat. No. 6,445,271 to Johnson issued Sep. 3, 2002 and entitled “Three-dimensional micro-coils in planar substrates”; U.S. Patent Publication No. 20060176139 to Pleskach; et al. published Aug. 10, 2006 and entitled “Embedded toroidal inductor”; U.S. Patent Publication No. 20060290457 to Lee; et al. published Dec. 28, 2006 and entitled “Inductor embedded in substrate, manufacturing method thereof, micro device package, and manufacturing method of cap for micro device package”; U.S. Patent Publication No. 20070001796 to Waffenschmidt; et al. published Jan. 4, 2007 and entitled “Printed circuit board with integrated inductor”; and U.S. Patent Publication No. 20070216510 to Jeong; et al. published Sep. 20, 2007 and entitled “Inductor and method of forming the same”.

One common approach to the manufacture of such inductors and inductive devices is the use of a magnetically permeable toroidal core. Toroidal cores are very efficient at maintaining the magnetic flux of an inductive device constrained within the core itself. Typically these cores (toroidal or not) are hand or machine wound with one or more magnet wire windings thereby fouuing an inductor or an inductive device (e.g. transformer, etc.).

These prior art hand- or machine-wound inductive devices, however, suffer from electrical variations due to, among other factors: (1) non-uniform winding spacing and distribution; and (2) operator error (e.g., wrong number of turns, wrong winding pattern, misalignment, etc.). Further, such prior art devices are often incapable of efficient integration with other electronic components, and/or are subject to manufacturing processes that are highly manual in nature, resulting in higher yield losses and driving up the cost of these devices. These disadvantages are exacerbated as the data rates traveling over these magnetically permeable cores increases.

Hence, there is a salient need for inductive devices that are both: (1) low in cost to manufacture; and (2) offer improved electrical performance over prior art devices. Ideally, such a solution would not only offer very low manufacturing cost and improved electrical performance for the inductor or inductive device, but also provide greater consistency between devices manufactured in mass production; i.e., by increasing consistency and reliability of performance by limiting opportunities for manufacturing errors of the device.

Furthermore, methods and apparatus for incorporating improved inductors or inductive devices into integrated connector modules as well as discrete device configurations are also needed.

### SUMMARY

In a first aspect, an improved substrate-based inductive device is disclosed. In one embodiment, the substrate-based inductive device is embodied within a discrete electronics package. In one variant, the discrete electronics package is a quad-flat no-leads (QFN) package.

In an alternative variant, the substrate-based inductive device includes a first substrate having a first plurality of apertures and a second substrate having a second plurality of apertures. One or more cores are disposed between the first and second substrates. Conductive wires are used to join respective ones of the first apertures with the second apertures, thereby forming the substrate-based inductive device.

In another variant, the substrate-based inductive device includes a plurality of choke coils (inductive reactors).

In yet another variant, the substrate-based inductive device includes a plurality of transformers.

In a further variant, the substrate-based inductive device is heterogeneous; i.e., includes a mix of different types of inductive components.

In a second aspect, a method of manufacturing the aforementioned substrate-based inductive device is disclosed.

In a third aspect, an electronics assembly and circuit comprising the substrate-based inductive device is disclosed. In one embodiment, the electronics assembly includes an integrated connector module. The integrated connector module includes a housing having at least one connector port and at least one recess and at least one insert assembly having conductive terminals configured to be at least partly received within the at least one port. A substrate inductive device is also included that has a first substrate having first apertures and a second substrate having second apertures. The substrate inductive device also includes one or more cores disposed between the first and second substrates. Conductive wires join respective ones of the first apertures with the second apertures.

In a fourth aspect, an electronics assembly and circuit comprising the substrate-based non-toroidal inductor is disclosed.

In a fifth aspect, a single port integrated connector module is disclosed.

In a sixth aspect, a method of manufacturing the single port integrated connector module is disclosed.

In a seventh aspect, a multi-port integrated connector module is disclosed.

In an eighth aspect, a method of manufacturing the multi-port integrated connector module is disclosed. In one embodiment, the method includes obtaining an integrated connector module housing; forming a substrate-based inductive device using a plurality of rectangular-oval shaped cores; forming a substrate-based inductive device assembly using the substrate-based inductive device; and inserting the substrate-based inductive device into the integrated connector module housing.

In a ninth aspect, networking equipment which utilizes the aforementioned single port and/or multi-port integrated connector modules is disclosed. In one embodiment, the networking equipment is an interne ₚrotocol (IP)-based switch. In an alternative embodiment, the networking equipment is an IP-based router.

In a tenth aspect, a spacer apparatus is disclosed. In one embodiment, the spacer apparatus is configured for use within a connector module having a plurality of substrate-based inductive devices.

In an eleventh aspect, an insert assembly is disclosed. In one embodiment, the insert assembly includes one or more substrate-based inductive devices, and is configured for use within a connector module (e.g., RJ-45 ICM).

In a twelfth aspect, a method of using a substrate-based inductive device is disclosed. In one embodiment, the method includes using at least one substrate-based inductive device to provide signal conditioning (e.g., filtration, voltage transformation, etc.) within a connector module that is part of a host device such as a network switch or router, such signal conditioning enabling operation at very high data rates (e.g., 10G or 10 Gbps).

### BRIEF DESCRIPTION OF THE DRAWINGS

The features, objectives, and advantages of the present disclosure will become more apparent from the detailed description set forth below when taken in conjunction with the drawings, wherein:

FIG. 1 is a perspective view of an integrated connector module comprised of substrate-based inductive device assemblies in accordance with one embodiment of the present disclosure.

FIG. 1A is a perspective view of the integrated connector module of FIG. 1, with the external EMI shields removed from view.

FIG. 1B is a perspective view of a substrate-based inductive device assembly for use in the integrated connector module of FIG. 1.

FIG. 1C is a perspective view of the substrate inductive device assembly of FIG. 1B, with the plug contact components (including FCC lead insert header and FCC substrate) removed from view.

FIG. 1D is a perspective view of one embodiment of a substrate-based inductive device useful with the substrate-based inductive device assembly of FIG. 1B.

FIG. 1E is a front view of the substrate-based inductive device of FIG. 1D.

FIG. 1F is a side view of the substrate-based inductive device of FIG. 1D.

FIG. 1G is a perspective view of the spacer used in the substrate-based inductive device assembly of FIG. 1B.

FIG. 1H is a side view of the substrate-based inductive device assembly of FIG. 1B.

FIG. 1I is a rear perspective view of the housing of the integrated connector module of FIG. 1.

FIG. 2 is a process flow diagram illustrating a method for manufacturing the integrated connector module of FIGS. 1-1I in accordance with one embodiment of the present disclosure.

All Figures disclosed herein are © Copyright 2012 Pulse Electronics, Inc. All rights reserved.

### DETAILED DESCRIPTION

Reference is now made to the drawings wherein like numerals refer to like parts throughout.

As used herein, the terms “electrical component” and “electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein, the term “integrated circuit” shall include any type of integrated device of any function, whether single or multiple die, or small or large scale of integration, including without limitation applications specific integrated circuits (ASICs), field programmable gate arrays (FPGAs), digital processors (e.g., DSPs, CISC microprocessors, or RISC processors), memory, and so-called “system-on-a-chip” (SoC) devices.

As used herein, the term “magnetically permeable” refers to any number of materials commonly used for forming inductive cores or similar components, including without limitation various formulations made from ferrite,

As used herein, the term “signal conditioning” or “conditioning” shall be understood to include, but not be limited to, signal voltage transformation, filtering and noise mitigation, signal splitting, impedance control and correction, current limiting, capacitance control, and time delay.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

### Overview

The present disclosure provides, inter alia, improved low cost and highly consistent inductive apparatus and methods for manufacturing, and utilizing, the same.

As previously noted, in a highly cost-competitive environment such as the electronics industry, the manufacturer of electronic devices with designs that minimize cost) will maintain a distinct advantage over competing manufacturers.

Various aspects of the present disclosure seek to minimize such costs by, inter alia, eliminating these highly manual prior art processes (such as manual winding of a toroid core), and improving electrical performance. This is accomplished by offering a design and method of manufacture which can automatically control, for example, winding pitch, winding spacing, winding distribution, and number of turns in a highly uniform and repeatable fashion. Hence, the present disclosure provides apparatus and methods that not only significantly reduce or even eliminate the “human” factor in precision device manufacturing (thereby allowing for greater performance and consistency), but also significantly reduces the cost of producing the device.

In addition, improved methods and apparatus are disclosed which make use and take advantage of these automated inductive apparatus. For example, integrated connector modules that incorporate the inductive apparatus disclosed herein, can take advantage of the benefits of these automated manufacturing processes by reducing cost and improving performance, as compared with prior art integrated connector modules that use wire wound magnetic components. Furthermore, the reliability and performance of the systems (such as telecommunications/networking equipment) which utilize these integrated connector modules also is improved.

### Detailed Description of Exemplary Embodiments

Detailed descriptions of the various embodiments and variants of the apparatus and methods of the present disclosure are now provided.

### Substrate Inductive Device Integrated Connector Modules

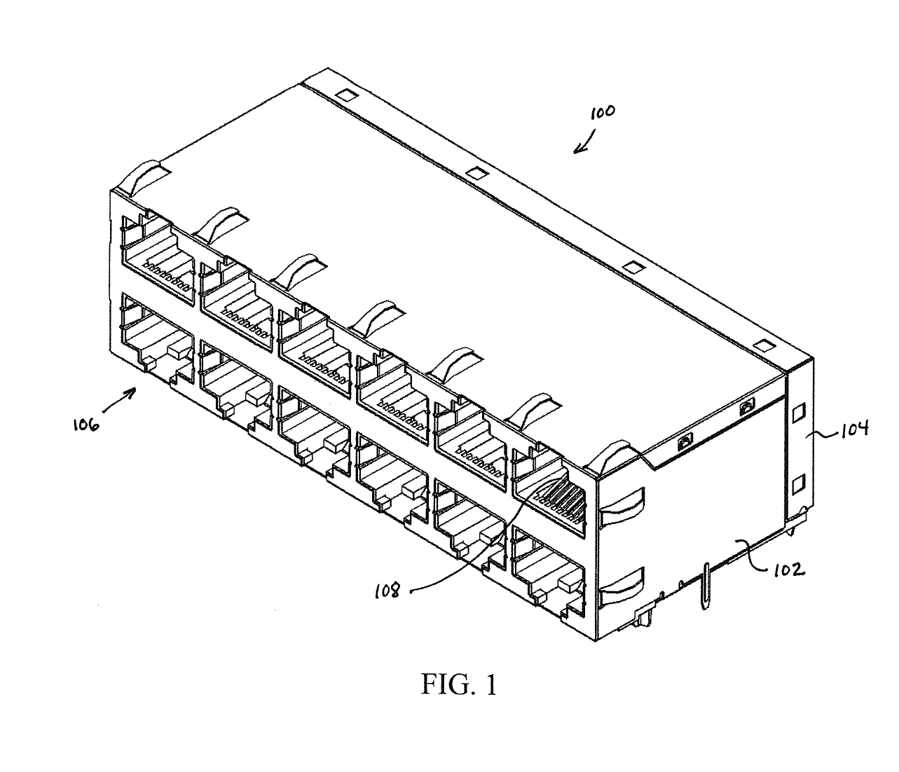

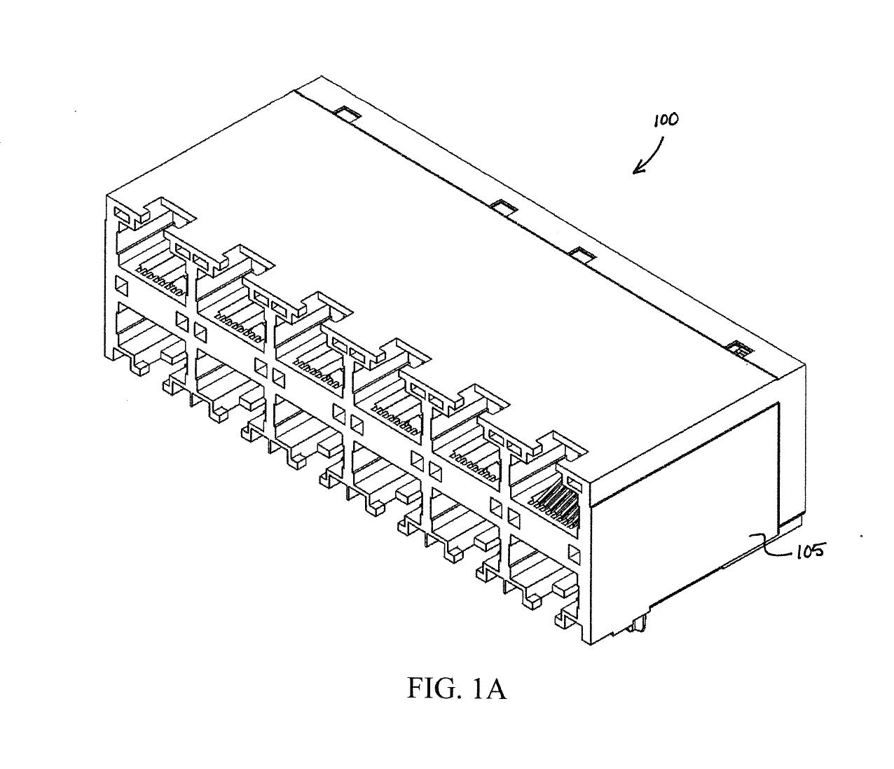

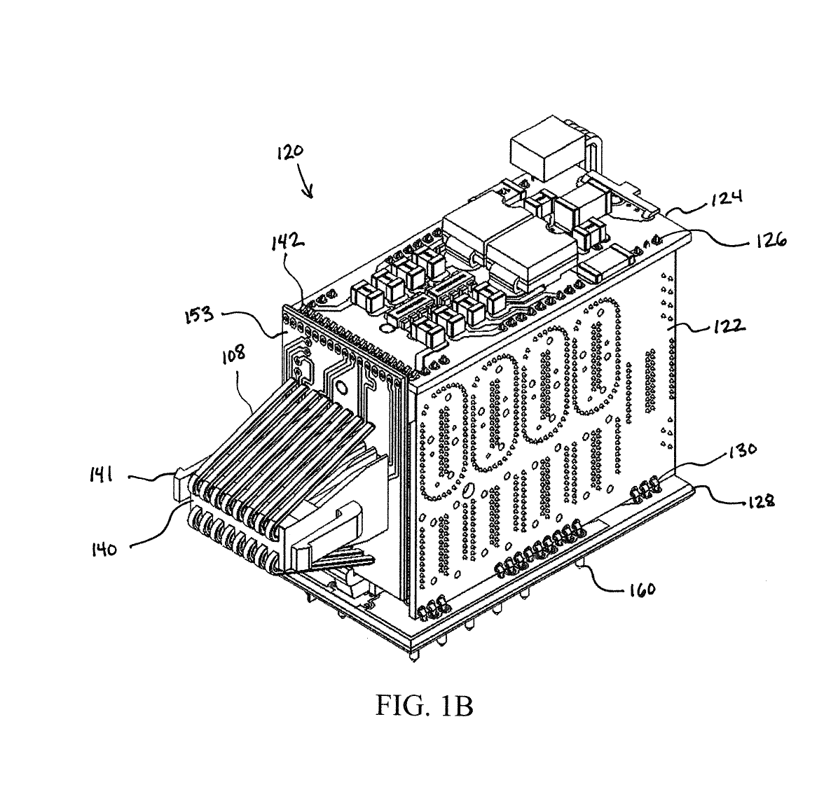

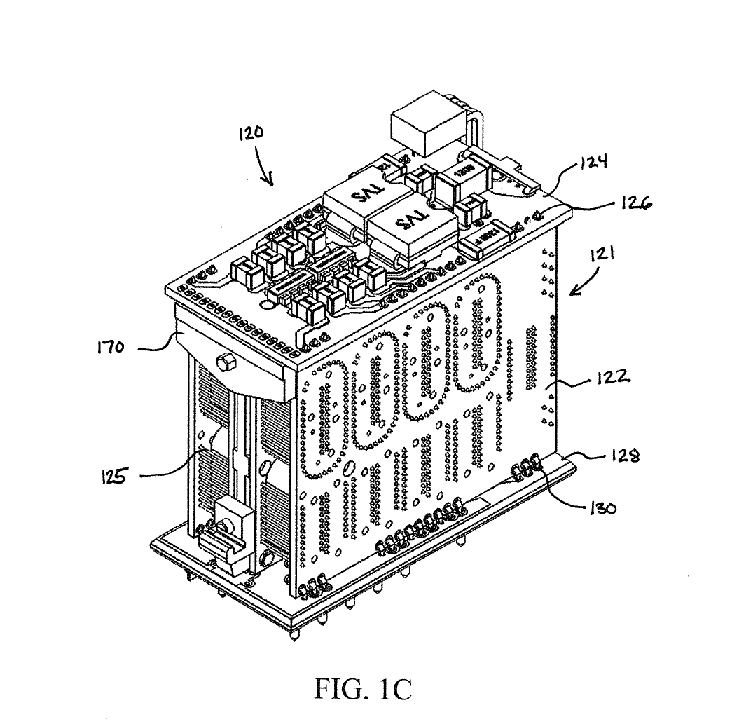

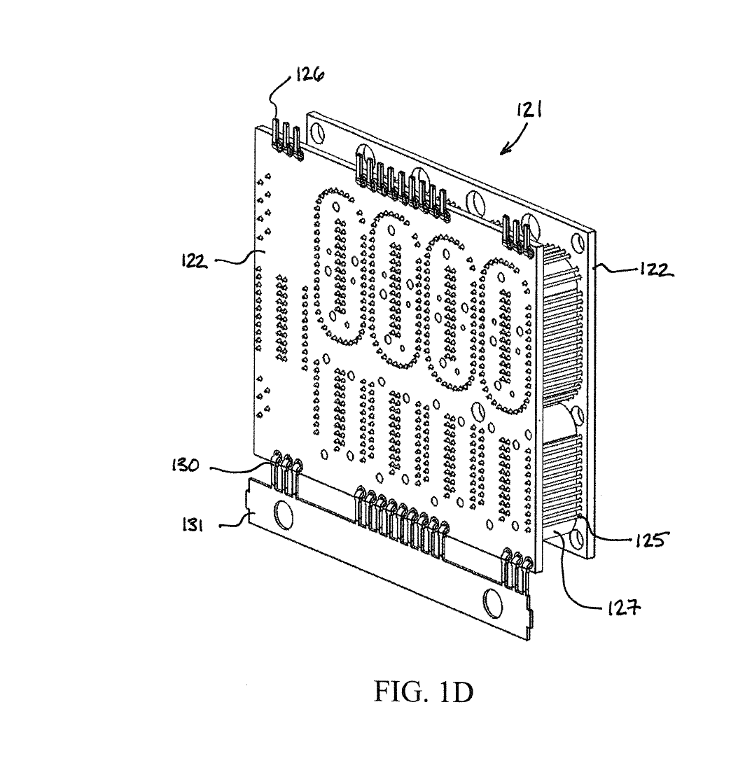

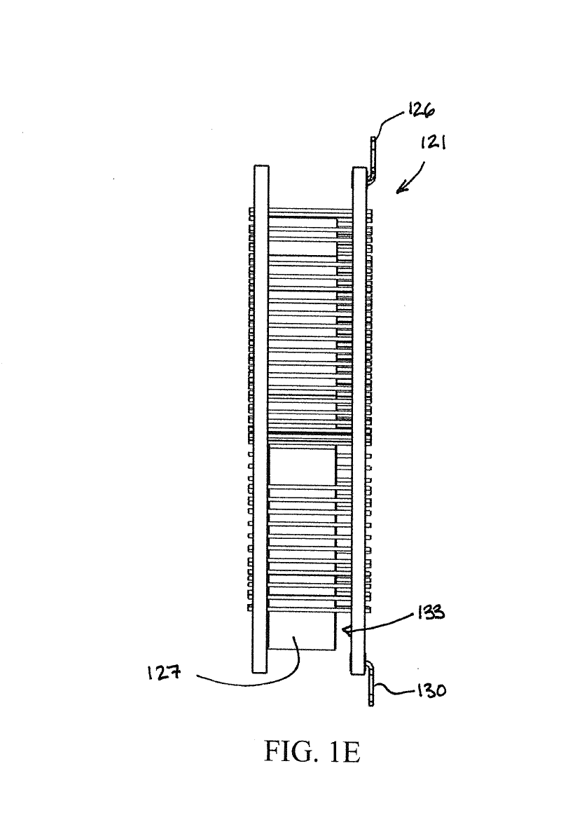

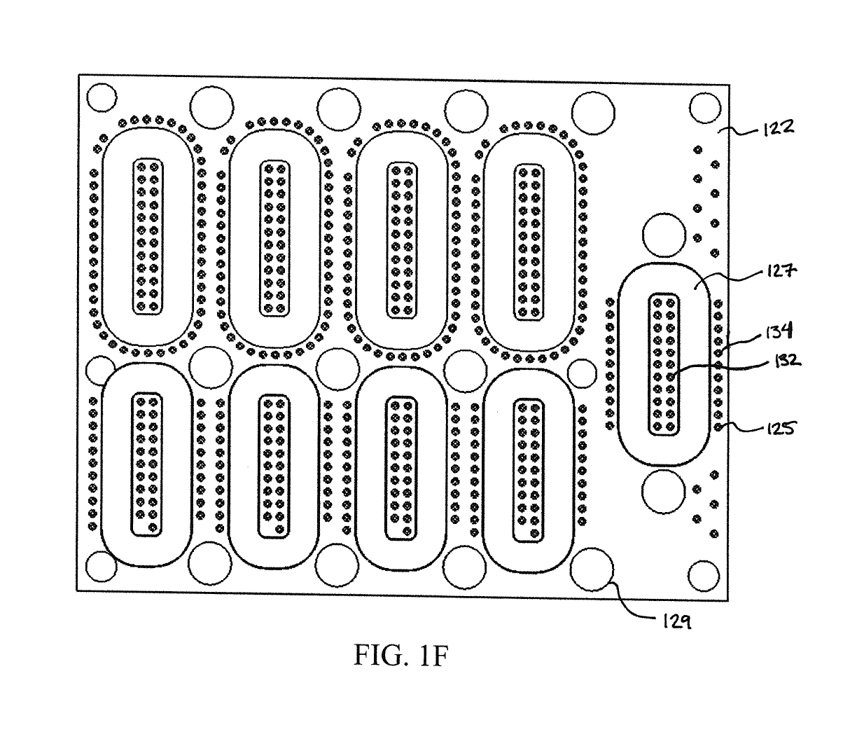

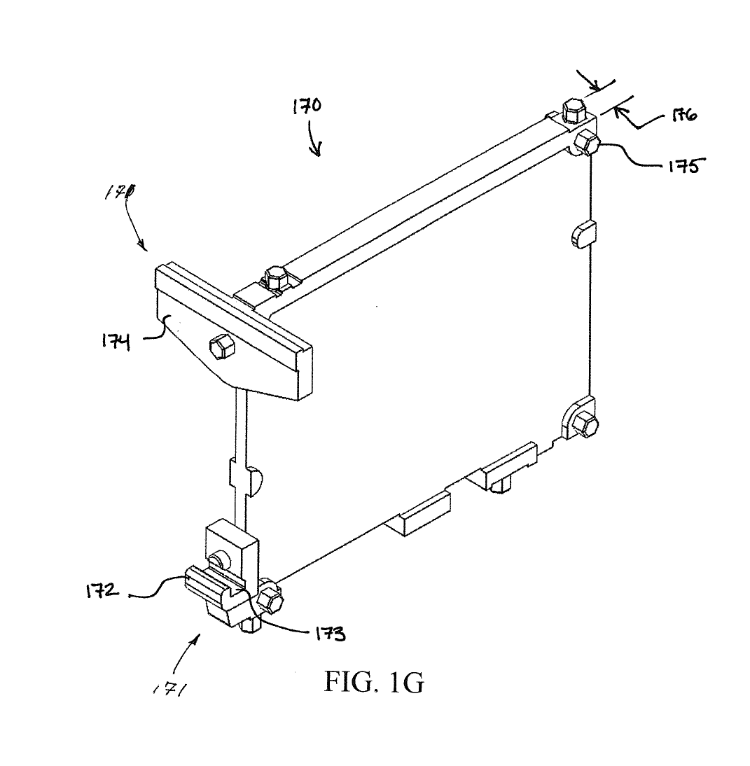

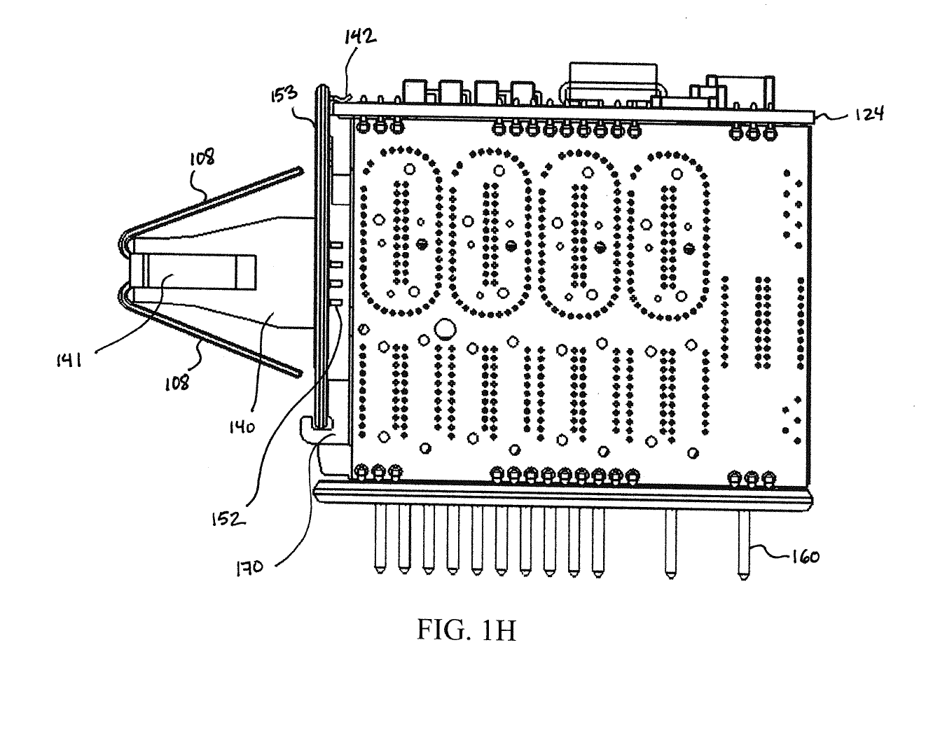

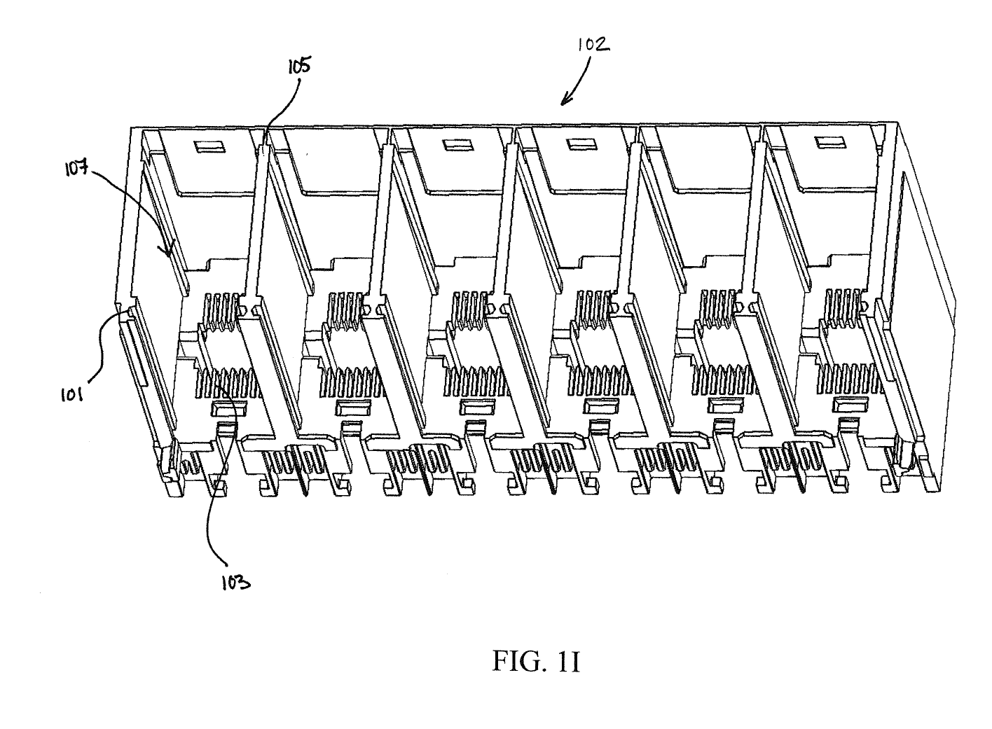

Referring now to FIGS. 1-1I, an exemplary embodiment of a multi-port substrate-based inductive device integrated connector module 100 is illustrated and described in detail. The term “integrated connector module” is used in the present context to refer without limitation to the fact that electronic components are utilized within the connector itself, as will be described in more detail subsequently herein.

FIG. 1 illustrates an integrated connector module 100 having a two-by-six (2×6) array of ports 106. Disposed within these ports are sets of conductors 108 (only one set of conductors is illustrated in FIG. 1) that are adapted for connection to an inserted male plug (e.g., RJ-45, or other) of the type well known in the telecommunications connector arts. It will be appreciated that while an RJ-45 type application is illustrated, the connector module of the present disclosure is in no way so limited, or in any way limited to a particular type of electrical connector (e.g., it can be used with other connector/plug types or form factors). Furthermore, while a specific multi-port integrated connector module is illustrated (i.e., a 2×6 array of ports), other multi-port variants are also envisioned including, without limitation, two-by-four (2×4) and two-by-eight (2×8) variants. Single port embodiments are also envisioned. Moreover, heterogeneous embodiments (e.g., RJ-over-USB), or SFP (small form-factor pluggable) are also envisioned.

In the illustrated embodiment, the connector module is comprised of two (2) external shielding elements including a front body shield 102 and a back body shield 104, although other configurations of shielding (e.g., one-piece) may be used. FIG. 1A illustrates the integrated connector module 100 with these shields removed from view so that the housing 105 can be readily seen. The housing is typically constructed from an injection-molded polymer that is well suited for mass-producing integrated connector housings, although other materials and forming processes may be used as dictated by the application.

FIG. 1B illustrates an exemplary substrate-based inductive device assembly 120 for use with the integrated connector module of FIG. 1. The substrate-based inductive device assembly embodiment illustrated includes seven (7) substrates. These substrates include an upper substrate 124 whose primary purpose in the illustrated embodiment is to provide a conductive interface 142, 126 between the FCC substrate 153 and the substrate inductive device substrates 122, as well as provide an additional mounting surface for discrete electronic components. This upper substrate can also accommodate light emitting diodes (LEDs) 111, that when used in combination with a light pipe, provides an indication on the front portion of the ICM. Conductive traces routed on this upper substrate electrically connect the conductive interfaces 142 with the substrate inductive device interfaces 126, and ultimately with the vertically oriented inductive device substrates 122 themselves (four in total in this embodiment). These vertically oriented substrates are in turn in electrical communication with a bottom substrate 128 via lower substrate conductive interfaces 130 that provide an electrical path between the vertically oriented substrates and the bottom substrate 128. Conductive traces (not shown) on the bottom substrate 128 then form an electrical connection between these substrate conductive interfaces 130 and conductive elements such as terminals 160 adapted for interfacing with an external motherboard (not shown). In this fashion, a signal path is formed between the sets of conductors 108 that interface with a modular plug and the conductive terminals 160 mounted on the bottom substrate 128.

The use and construction of substrate-based inductive device assemblies is exemplified in co-owned U.S. patent application Ser. No. 12/876,003, filed Sep. 3, 2010, and entitled “Substrate Inductive Devices and Methods”, the contents of which are incorporated herein by reference in its entirety.

In an alternative embodiment to that illustrated, the bottom substrate 128 previously illustrated and described with respect to, for example FIG. 1B, is substituted with a low-cost alternative. This low cost-alternative comprises in one implementation a relatively thin substrate coupled with a polymer header. For example, in one embodiment, the bottom substrate illustrated in FIG. 1B is sixty-two thousandths of an inch thick (0.062″). An alternative implementation uses a thinner substrate (e.g. thirty-two thousandths of an inch (0.032″)) coupled with a thirty-two thousandths of an inch thick sheet of an injection-molded polymer. In this alternative implementation, the polymer sheet acts to provide additional support for the terminals 160 that are secured to the thinner substrate. Further, the combination of a thinner substrate with the polymer sheet is in many cases lower in cost to manufacture and/or procure than the cost of the thicker substrate described previously herein. Furthermore, the FCC substrate and/or the upper substrate can also readily be substituted with the above mentioned polymer header. Each of these alternative polymer substrates can also be insert molded with a conductive lead frame which acts as an alternative to the traces described above with regards to substrates (such as fiber-glass based substrates).

As will be discussed in further detail subsequently herein, the substrate-based inductive devices are constructed via the routing of conductive wires on both the inner portion and outer portion of individual cores. The spacing between individual conductive wires is, in many useful embodiments, tightly constrained or of very small pitch (as best illustrated in FIG. 1D), and the potential for high potential arcing between adjacent conductive wires can be problematic if not properly addressed. While the conductive wires themselves are typically insulated (e.g., through the use of vapor deposited parylene or similar insulative material), the electrical isolation between adjacent conductive wire portions within the substrates is only provided via the insulating properties of the substrate itself. Accordingly, the substrate itself must be constructed so as to mitigate the potential for high potential arcing via voids or other inclusions within the substrate. Typically, substrates are constructed using laminated layers of epoxy resin “prepregs” which include, for example, woven or unidirectional fiberglass fibers. These fiberglass fibers typically have a circular cross section. However, in order to mitigate the presence of voids or inclusions within the substrate, the present disclosure uses, in an exemplary embodiment, flattened fiberglass fibers and a higher ratio of epoxy to fiberglass than is typically used in many electronics applications in order to improve the electrical isolation properties of the substrate itself.

As discussed above, the integrated connector module of FIG. 1 and the exemplary substrate inductive device assembly 120 of FIG. 1B include a through hole-type connection; i.e., the terminals 160 for mounting to an external substrate are adapted to penetrate through respective apertures formed in an external printed circuit board or motherboard. The terminals are soldered to conductive traces located on this external printed circuit board that immediately surrounds the apertures on this external printed circuit board, thereby forming a permanent electrical contact there between. However, it will be appreciated that other mounting techniques and configurations may be used consistent with the present disclosure. For example, the terminals 160 may be formed in such a configuration so as to permit surface mounting of the connector assembly 100 to the external printed circuit board, thereby obviating the need for apertures. Such surface mounting techniques are described in, for example, co-owned U.S. Pat. No. 7,724,204 to Annamaa, et al. issued May 25, 2010 and entitled “Connector antenna apparatus and methods”, the contents of which are incorporated herein by reference in its entirety.

As another alternative, the connector assembly may be mounted to an intermediary substrate (not shown), the intermediary substrate being mounted to the external printed circuit board via a surface mount terminal array such as a ball grid array (BGA), pin grid array (PGA), or other similar mounting technique.

Additionally, the use of press-fit interconnects of the type known in the electronic arts could be readily substituted as well. The use of press-fit interconnects and the underlying structure for integrated connector modules for use with these press-fit interconnects is described in co-owned U.S. Provisional Patent Application Ser. No. 61/639,739, filed Apr. 27, 2012 and entitled “Shielded Integrated Connector Modules and Assemblies and Methods of Manufacturing the Same”, the contents of which are incorporated herein by reference in its entirety. These and other alternatives would be readily apparent to one of ordinary skill given the present disclosure.

The substrate-based inductive device assembly 120 also includes an FCC insert 140. The FCC insert includes the aforementioned ICM conductors 108 within a polymer header. The polymer header acts to maintain the ICM conductors in a pre-arranged configuration so as to enable interoperation with industry standard plugs. The polymer header also includes a pair of snap features 141 that aid in securing the substrate-based inductive device assembly to the ICM housing. The FCC insert can also advantageously incorporate a conductive ground plane between the upper and lower conductors 108. This conductive ground plane can then be coupled to a ground plane on the FCC substrate so as to provide electromagnetic shielding between the upper and lower conductors. The use of electromagnetic shielding mitigates the effects of interference and crosstalk between the adjacently situated upper and lower conductors. As previously alluded to above, while the FCC insert is illustrated coupled to the FCC substrate 153, it is appreciated that alternative implementations (not shown) can obviate the need for the FCC substrate and instead couple the FCC conductors 108 directly to the upper substrate 124.

FIG. 1C illustrates the substrate-based inductive device assembly 120 with the lead (e.g., FCC) insert assemblies removed from view so that a view of the vertically oriented substrates 122, 123 that make up the substrate inductive devices 121 are more readily visible. Each substrate inductive device 121 is comprised of an outer vertically oriented substrate 122 and an inner vertically oriented substrate 122 in the illustrated embodiment, although other configurations (e.g., with more substrates, and/or oriented in a different fashion such as parallel to the connector front face, or disposed sideways so as to be lying flat) are envisaged. These substrate inductive devices are separated by a spacer 170 which electrically isolates the substrate inductive devices from one another, as well as helps set the proper width for the substrate inductive device assembly 120. Each pair of vertically oriented substrates 122 that makes up the substrate inductive device 121 provides the signal conditioning function for a single port on the multi-port integrated connector module in the illustrated embodiment.

In an exemplary embodiment, each of substrate conductive interfaces 130 between the substrate inductive device 121 and the bottom substrate 128 reside solely on the outer vertically oriented substrate 122, so that they are more readily accessible during both soldering operations and during inspection. However, it is also envisioned these substrate conductive interfaces 130 could also conceivably be located on the inner vertically oriented substrates as well. Additionally, it is also possible to include these conductive interfaces on both the inner and outer substrates in some embodiments.

It will be appreciated that while exemplary embodiments of the substrate inductive devices set forth herein have electronic components disposed on e.g., the upper substrate 124, the vertically oriented substrates 122 of the substrate inductive devices may feasibly be used for this purpose as well, such as where some or all of these electronic components (e.g., resistors, capacitors, etc.) are disposed on the free regions of one or more of the vertical substrates 122.

In an exemplary embodiment, the vertically oriented substrates 122 are manufactured without the use of a solder mask. In other words, the fiberglass-based substrates are manufactured without the use of a protective lacquer-like coating that protects the traces from solder bridging and oxidation. One reason for the removal of the solder mask is that, in an exemplary embodiment, these substrate-based inductive device assemblies will be coated with a non-conductive coating after assembly. In an exemplary embodiment, this non-conductive coating will include a vapor deposited parylene coating. This vapor deposited parylene coating is used so as to provide electrical isolation between adjacent substrate-based inductive device conductive wires. By removing the solder mask from these substrates, adherence for the deposited non-conductive coating is enhanced over the deposition of these coatings onto the solder mask, thereby improving the performance and reliability of this added non-conductive coating (e.g. parylene).

FIG. 1D illustrates an exemplary embodiment of a single substrate-based inductive device 121 in detail. More specifically, the substrate inductive devices are comprised of the two vertically oriented substrates 122 with a number of magnetically permeable cores 127 sandwiched there between (here nine (9)). These magnetically permeable cores are, in the illustrated embodiment, positioned in a four-by-two (4×2) array with a single core being positioned on the back end of this array. Disposed both within the center aperture of the cores as well as surrounding the peripheries of the cores are conductive wires 125. The cores themselves are composed of a rectangular-oval (“royal”) shape, which facilitates the routing of the conductive wires about each of the cores. More specifically, because the inner volume of the royal core has been elongated, it is easier to route and position the conductive wires within this area that would otherwise be constrained in, for example, a pure toroid embodiment.

Accordingly, such a configuration enables a variety of different winding configuration implementations. Herein lies a salient advantage of the present disclosure over prior wire wound toroidal configurations. The use of the vertically oriented substrates in order to position the conductive windings about the cores allows for the accurate and repeatable placement of the windings about each of the cores. This accurate and repeatable placement of the “windings” in turn results in accurate and repeatable inductive device performance. Furthermore, in the context of high-speed data applications, transformer embodiments of prior art wire wound cores were often limited to simple turns ratio implementations (e.g. one-to-one) so as to provide a wound transformer with adequately consistent electrical properties. The consistency was in large part due to the ability to ensure consistent coupling between the primary and secondary windings of the transformer. This consistent coupling is easier to accomplish with simple turns-ratios like one-to-one, as the primary and secondary windings could be twisted together which is not a practical solution for more complex turns-ratio implementations. The substrate-based inductive device in the illustrated embodiment is not so limited. In fact, any number of turns-ratio (e.g. one-to-root two) implementations can be accurately placed in a highly repeatable manner. In other words, because the placement of the windings about the core (e.g. Royal core) can be precisely controlled, the coupling between the primary and secondary windings can also be precisely controlled, even when using complex turns ratio configurations. Such flexibility is made possible due to the precise placement of the conductive wires. As used herein, the term “complex turns ratio configurations” refers to the fact that coupling between the primary and secondary windings is difficult to control using prior art wire wound techniques such as wire twisting, etc.

The inserted conductive wires placed within these vertically oriented substrates are precisely inserted using a customized wire insertion machine. These conductive wires are inserted and singulated off a coiled wire spool containing straightened conductive wire. In an exemplary embodiment, this coiled wire spool is constructed by first stretching the wire past its yield strength but prior to reaching its ultimate strength so as to prevent necking. By stretching the wire in this fashion, the elastic memory contained within this wire (typically wound on a smaller wound coil) is removed and the conductive wire will tend to come off of the coiled wire spool in a straighter fashion than would be possible without this stretching operation. This straightened coiled wire spool can then be inserted into the vertically oriented substrates more precisely than would otherwise be possible. Specifically, during insertion, automated vision equipment will line up an end of the conductive wire to be inserted with its respective apertures located on the vertically oriented substrates. If the length of conductive wire to be inserted was relatively straight (i.e. without a significant curve or “memory” resultant from its storage onto a spool), the insertion process is appreciably simplified. Note that this primarily results from the fact that these inserted conductive wires are inserted through two separate apertures that are separated from one another by a sufficient distance that enables the accommodation of magnetically permeable cores there between.

Prior to insertion, the vertically oriented substrates will, in an exemplary embodiment, be visually inspected. This visual inspection involves the use of automated vision equipment which can quickly ensure that the respective substrates do not contain manufacturing flaws or defects which can adversely affect the insertion of these conductive wires into these relatively small substrate apertures. Due to the large number of conductive wires inserted, the smallest defect (e.g., a partial blockage of an aperture that is to receive an inserted conductive wire) can significantly affect yield when producing the substrate inductive devices using automated wire insertion equipment. Furthermore, due to the large number of conductive wires to be inserted in a typical substrate-based inductive device application, errors associated with wire insertion resultant from defects in a substrate can detrimentally the efficiency and throughput of this automated wire insertion equipment.

FIG. 1D also illustrates the construction of the conductive interfaces 126, 130. The upper conductive interfaces 126 are illustrated in their final form prior to being joined to the upper substrate, while the lower conductive interfaces 130 are illustrated still attached to their conductive interface carriers 131. The conductive interface carriers 131 facilitate the manufacture and placement of the conductive interfaces onto the vertical substrates 122. After installation onto the vertical substrates, the conductive interface carriers are removed (as shown with respect to the upper conductive interfaces 126).

FIG. 1E illustrates the substrate-based inductive device 121 from an end-on perspective that shows the gap 133 between the cores 127 and one of the vertically oriented substrates 122. In the illustrated embodiment, the cores are secured to the inside vertically oriented substrate (i.e. the substrate adjacent the spacer 170 shown in FIG. 1G) using an epoxy. The gap between the cores and the opposing vertical substrate provides room for thermal expansion during subsequent processing steps. This gap prevents the opposing vertical substrates from being pushed apart by the thermal expansion of the core and epoxy during operations where the substrate inductive device (e.g. during curing or soldering operations, etc.). In an exemplary embodiment, epoxy is disposed at select locations on one of the substrates of the substrate-based inductive device. The cores are then placed onto the substrate at each of these selected locations. The substrate with the cores is then placed into a fixture that is used to support the adjacent substrate such that the gap 133 between the adjacent substrate and the cores is set at a predetermined distance. Subsequent to wire insertion and soldering, the fixture is removed and the gap between the core and adjacent substrate is maintained. While the disposition of the core on the inside vertically oriented substrate, it is appreciated that the cores can also be disposed on the outer vertically oriented substrate as well if desired. Furthermore, it is appreciated that cores can be placed on both the inner and outer substrate, but not both simultaneously. In other words, half the cores could be placed on the inner substrate while the other half of the cores could be placed on the outer substrate. These and other embodiments would be readily apparent to one of ordinary skill given the present disclosure.

Referring now to FIG. 1F, a side view of the substrate inductive device illustrated in FIG. 1D is shown and described in detail. Specifically, FIG. 1F more clearly illustrates the advantages of using a royal-shaped core 127. Each royal-shaped core has conductive wires 125 placed on both the inner portion 132 and outer portion 134 of the royal-shaped core. Due to the elongated nature of the royal-shaped core, more conductive wires can be positioned within the inner portion 132 of the royal-shaped core than would otherwise be possible using more traditional cores (such as toroid cores). For example, in the illustrated embodiment, twenty-two (22) conductive wires are included in the inner portion of the royal-shaped core residing on the right-hand side of the printed circuit board 122. If this royal-shaped core were substituted with a toroid shaped core having a similarly-sized cross sectional area, less than about eight (8) conductive wires could be accommodated within the inner portion of this theoretical toroid shaped core. Also illustrated are alignment apertures 129 which helps facilitate the positioning of the substrate 122 with respect to other components within the substrate inductive device assembly.

Referring now to FIG. 1G, one embodiment of the spacer 170 adapted for disposal between adjacent ones of substrate inductive devices is shown and described in detail. The spacer comprises a predetermined width 176 so that the spacer in combination with the substrate inductive devices possesses the port cavity width of the integrated connector module. Furthermore, this width 176, as previously discussed herein, provides increased electrical isolation between adjacent substrate inductive devices. In an exemplary embodiment (not shown), the spacer can accommodate a conductive metal sheet within the body of the spacer. This conductive metal sheet can be insert-molded into the body of the spacer or alternatively, can be post-inserted into the body of the spacer via the inclusion of an integrated groove (not shown). Via the inclusion of this conductive metal sheet, electromagnetic shielding can be provided between adjacent substrate-based inductive devices. The use of shielding to provide electrical isolation within an integrated connector module is described in co-owned and co-pending U.S. Provisional Patent Application Ser. No. 61/639,739 filed Apr. 27, 2012 and entitled “Shielded Integrated Connector Modules and Assemblies and Methods of Manufacturing the Same”, the contents of which are incorporated herein by reference in its entirety. Co-owned U.S. Pat. No. 6,585,540 filed on Dec. 6, 2000 and entitled “Shielded Microelectronic Connector Assembly and Method of Manufacturing”, the contents of which are incorporated herein by reference in its entirety, also discloses methods and apparatus for the provisioning of electrical shielding within an integrated connector module that are useful with embodiments of the present disclosure.

In the illustrated embodiment, the spacer 170 also serves an alignment function wherein it aligns all of the adjacently-placed substrate inductive devices 121 (FIG. 1D) prior to their insertion into the integrated connector module housing. Alignment posts 175 are utilized in combination with respective apertures in the adjacently placed substrates to facilitate the alignment of the adjacent substrates with respect to the spacer 170. Integrally formed onto the front portion of the spacer is an FCC insert mounting bracket 171 that includes a lower mounting portion 172 and an upper mounting portion 174. The lower mounting bracket includes a groove 173 sized to accommodate the width of the FCC substrate, while the upper mounting portion accommodates the substrates underneath an aligning ridge. The combination of the upper and lower mounting portions 174, 172 advantageously enables the positioning of the FCC substrate without the use of secondary processing techniques such as epoxies, heat staking, etc. However, the use of secondary processing techniques could be used in addition to, or as an alternative to, the arrangement illustrated in FIG. 1G. In addition, while the use of the FCC insert mounting bracket 171 is exemplary, it is appreciated that in some embodiments it may be desirable to attach the FCC substrate directly to one or more of the other substrates present (e.g. the substrate inductive device substrates).

FIG. 1H illustrates a side view of the substrate-based inductive device assembly 120 so that various aspects of its construction are now more readily visible. The FCC substrate 153 is shown positioned within the spacer 170 as described previously herein with respect to FIG. 1G. Positioned onto the FCC substrate is the FCC insert 140 having associated FCC conductors 108 and a snap feature 141 which secures the FCC insert to the integrated connector module housing when the substrate-based inductive device assembly is mounted therein. Furthermore, because the FCC insert mounting bracket 171 is divided into an upper portion 174 and a lower portion 172, clearance is provided for the FCC terminals 152 that are inserted through the FCC substrate. Conductive interfaces 142 electrically connect the FCC substrate to the upper substrate 124.

FIG. 1I illustrates various features of an integrated connector module housing 102 useful with the substrate inductive device assemblies of the present disclosure. The housing includes a rear cavity 107 that is separated from the modular plug receiving ports via a dividing wall. Comb-like features 103 incorporated into the connector housing internal divider wall are used to maintain separation between adjacent ones of module plug interfacing connector terminals (FIG. 1, 108). Lateral dividing walls 105 separate adjacent columns of ports and include and alignment track 101 that is sized to accommodate the insertion of the bottom substrate of the inserted substrate-based inductive device assembly. The underlying structure of the housing can be readily modified to accommodate any number of known configurations. For example, various features of the housing for use with features such as, without limitation, externally mounted light-emitted diodes (LEDs) and light pipes such as that disclosed in co-owned U.S. Pat. No. 6,962,511 to Gutierrez, et al. issued Nov. 8, 2005 and entitled “Advanced microelectronic connector assembly and method of manufacturing”, which is incorporated herein by reference in its entirety, may be readily adapted for use with the substrate inductive devices described herein. These can be used in addition to, or as an alternative to, the configuration illustrated in FIG. 1B.

Furthermore, housings which can incorporate multiple application-specific inserts such as those described in co-owned U.S. Pat. No. 7,241,181 to Machado, et al. issued Jul. 10, 2007 and entitled “Universal connector assembly and method of manufacturing”; co-owned U.S. Pat. No. 7,367,851 to Machado, et al. issued May 6, 2008 of the same title; co-owned U.S. Pat. No. 7,661,994 to Machado, et al. issued Feb. 16, 2010 of the same title; and co-owned U.S. Pat. No. 7,959,473 to Machado, et al. issued Jun. 14, 2011 of the same title, the contents of each of the foregoing incorporated herein by reference in their entirety, can also be readily incorporated within the substrate-device based connector assembly disclosed herein. For example, the application-specific insert described in the above-mentioned U.S. patents can be modified so as to include application-specific substrate inductive device assemblies. These substrate inductive device assemblies can incorporate differing electronic components and/or differing mounting footprints within a common integrated connector module housing.

Housings which incorporate integrated keep-out features such as those disclosed in co-owned U.S. Pat. No. 7,708,602 to Rascon, et al. issued May 4, 2010 and entitled “Connector keep-out apparatus and methods”, which is incorporated herein by reference in its entirety, can also be included in desired embodiments in which is desirable to, for example, prevent the insertion of modular plugs that are not otherwise intended to be inserted into the underlying integrated connector module. Other housings for use in active integrated connector modules such as that described in co-owned U.S. Pat. No. 7,524,206 to Gutierrez, et al. issued on Apr. 28, 2009 and entitled “Power-enabled connector assembly with heat dissipation apparatus and method of manufacturing”, which is incorporated herein by reference in its entirety, can also be readily adapted for use with the substrate inductive device assemblies described herein. These and other configurations would be readily apparent to one of ordinary skill given the present disclosure.

### Methods of Manufacture

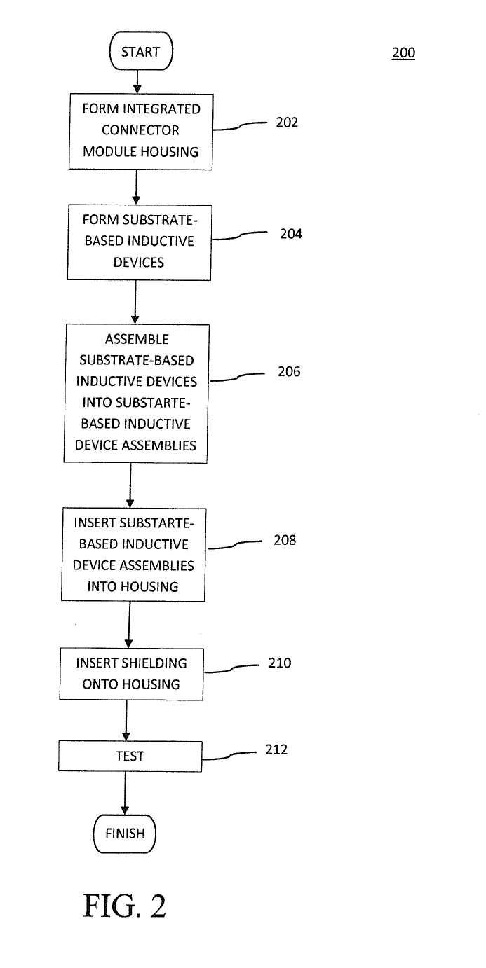

Referring now to FIG. 2, one exemplary embodiment of the method for manufacturing a substrate-based inductive device integrated connector module 200 is shown and described in detail.

It will be appreciated that while the following method is described primarily in the context of the multi-port integrated connector module of FIGS. 1-1I discussed supra, the methodology may be readily adapted to single-port integrated connector modules, and in fact other types of connectors, such adaptation being well within the skill of the ordinary artisan given the present disclosure.

At step 202, the integrated connector module housing is fowled. In one exemplary embodiment, the integrated connector module housing is formed using an injection molded polymer using a well-known injection molding process. The housing may alternately be procured from a third party.

At step 204, the substrate-based inductive devices are formed. In one embodiment, magnetically permeable cores and substrates are obtained, and the cores secured to one substrate within a pair of substrates. This is accomplished by depositing an adhesive (e.g., epoxy-based) onto the substrate in prescribed regions (e.g., where the cores will sit), and then placing the magnetically permeable cores onto this adhesive. The adhesive is then cured if required so as to secure the core onto the substrate.

Next, the substrate with the cores attached thereto is secured within an alignment fixture. A second substrate is placed onto the alignment fixture. The alignment fixture maintains a fixed distance relationship between the two substrates so as to ensure a gap between the magnetically permeable core and the second substrate. The fixture is then loaded into an automated wire insertion machine which in one implementation, utilizes vision equipment to accurately dispose conductive wires into corresponding (i.e., aligned) apertures present on each of the two substrates. The conductive wires are then secured via a eutectic soldering operation. In an exemplary embodiment, the eutectic solder is deposited onto the substrates using known techniques (e.g. a solder past printing machine, screen printing, etc.) and then sent through a reflow oven in order to secure the substrates to these conductive wires. Other soldering approaches such as wave-soldering may be used as well. The formed substrate inductive devices are then placed into a vacuum chamber so that a parylene coating can be applied to the entire formed substrate inductive device. At step 206, the substrate-based inductive devices are assembled into substrate-based inductive device assemblies (see FIG. 1B). First, the substrate-based inductive devices are processed to remove the parylene coating from portions of the device that will need to be accessed for subsequent soldering operations. In an exemplary embodiment, this is accomplished via the use of laser ablation techniques of the type well known in the electronic arts.

Next the various substrates, spacer and FCC inserts are assembled together and secured to one another via a eutectic soldering operation, or alternatively via alternative securing techniques such as resistance welding and the like. At this point, the substrate-based inductive device assemblies are ready for insertion into the integrated connector module housing formed at step 202.

At step 208, the substrate-based inductive device assemblies are inserted into the integrated connector module housing. In an exemplary embodiment, the substrate-based inductive device assemblies are secured to the housing via the mechanical snaps present on the FCC insert (141, FIG. 1B). In addition to, or as an alternative to the mechanical snap mechanism, the substrate-based inductive device assemblies can be secured via secondary processing techniques such as epoxy adhesives, heat staking, etc.

At step 210, shielding is inserted onto the housing (if shielding is to be used). In an exemplary embodiment, the shielding consists of a two-part shield with a main body shield inserted onto the housing followed by a back shield that is secured to the main body shield using, for example, mechanical snaps. At step 212, the integrated connector module is optionally tested to ensure that the module operates as intended.

It will again be noted that while certain aspects of the present disclosure are described in terms of a specific sequence of steps of a method, these descriptions are only illustrative of the broader methods of the present disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure disclosed and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

What is claimed is:

1. A substrate inductive device, comprising:
a first substrate comprised of a first plurality of apertures;
a second substrate comprised of a second plurality of apertures;
one or more cores disposed between the first and second substrates; and
a plurality of conductive wires, the conductive wires joining respective ones of the first apertures with the second apertures, thereby fowling the substrate inductive device.

2. The substrate inductive device of claim 1, further comprising a third substrate comprised of a third plurality of apertures and a fourth substrate comprised of a fourth plurality of apertures;
one or more cores disposed between the third and fourth substrates; and
a plurality of conductive wires, the conductive wires joining respective ones of the third apertures with the fourth apertures, thereby forming a portion of the substrate inductive device.

3. The substrate inductive device of claim 2, further comprising a spacer element, the spacer element separating the first and second substrates from the third and fourth substrates.

4. The substrate inductive device of claim 3, wherein the spacer element also serves an alignment function for at least one of the first and second substrates and at least one of the third and fourth substrates.

5. The substrate inductive device of claim 3, wherein each of the first, second, third and fourth substrates are manufactured without the use of a solder mask thereby enabling the application of a non-conductive coating after the conductive wires have joined the respective substrates.

6. The substrate inductive device of claim 1, wherein the one or more cores comprise a rectangular-oval (“royal”) shape thereby increasing an inner volume of the one or more cores over a toroid core shape.

7. The substrate inductive device of claim 6, wherein the increased inner volume of the royal shape enables use of a highly repeatable complex turns ratio.

8. The substrate inductive device of claim 6, further comprising a gap between the one or more cores and one of the first or second substrates.

9. An integrated connector module, comprising:
a housing having at least one connector port and at least one recess; and
at least one insert assembly, the at least one insert assembly comprising a plurality of conductive terminals configured to be at least partly received within the at least one port, and a substrate inductive device comprising:
a first substrate comprised of a first plurality of apertures;
a second substrate comprised of a second plurality of apertures;
one or more cores disposed between the first and second substrates; and
a plurality of conductive wires, the conductive wires joining respective ones of the first apertures with the second apertures.

10. The integrated connector module of claim 9, further comprising an insert assembly substrate, the insert assembly substrate configured to receive the at least one insert assembly.

11. The integrated connector module of claim 10, further comprising an upper substrate, the upper substrate providing an interface path between the insert assembly substrate and the first and second substrates comprised of the first and second plurality of apertures, respectively.

12. The integrated connector module of claim 11, further comprising a bottom substrate, the bottom substrate providing an external interface path between an external printed circuit board and the first and second substrates comprised of the first and second plurality of apertures, respectively.

13. The integrated connector module of claim 12, wherein the first and second substrates, along with the insert assembly substrate are disposed vertically while the upper substrate and the bottom substrate are disposed horizontally.

14. The integrated connector module of claim 11, wherein a gap is provided between the one or more cores and one of the first or second substrates.

15. The integrated connector module of claim 9, wherein the at least one insert assembly further comprises a polymer header configured to at least partially house the plurality of conductive terminals.

16. The integrated connector module of claim 15, wherein the at least one insert assembly comprises a plurality of upper conductive terminals and a plurality of lower conductive terminals with the polymer header comprising a conductive ground plane disposed between the plurality of upper and lower conductive terminals.

17. The integrated connector module of claim 9, wherein the one or more cores comprise a rectangular-oval (“royal”) shape thereby increasing an inner volume of the one or more cores over a toroid core shape.

18. The integrated connector module of claim 17, wherein the increased inner volume of the royal shape enables use of a highly repeatable complex turns ratio.

19. A method of manufacturing an integrated connector module, comprising:
obtaining an integrated connector module housing;
forming a substrate-based inductive device using a plurality of rectangular-oval shaped cores;
forming a substrate-based inductive device assembly using the substrate-based inductive device; and
inserting the substrate-based inductive device into the integrated connector module housing.

20. The method of manufacturing the integrated connector module of claim 19, further comprising:
forming a complex turns ratio for the plurality of rectangular-oval shaped cores;
wherein the act of forming the complex turns ratio comprises inserting a plurality of conductive wires into a plurality of respective apertures resident within a first and a second substrate of the substrate-based inductive device.
